(19) United States
(12) Patent Application Publication
(10) Pub. No.: US 2025/0013534 A1
(43) Pub. Date: Jan. 9, 2025

(54) TECHNIQUES FOR DATA PATH ADDRESS PROTECTION

(71) Applicant: Micron Technology, Inc., Boise, ID (US)

(72) Inventors: Michael Dieter Richter, Ottobrunn (DE); Casto Salobrena Garcia, Munich (DE); Wolfgang Anton Spirkl, Germering (DE); Thomas Hein, Munich (DE); Peter Mayer, Neubiberg (DE)

(21) Appl. No.: 18/762,327

(22) Filed: Jul. 2, 2024

Related U.S. Application Data
(60) Provisional application No. 63/512,480, filed on Jul. 7, 2023.

(51) Int. Cl. G06F 11/10

(52) U.S. Cl. CPC G06F 11/1068; G06F 11/1016

(57) ABSTRACT

Methods, systems, and devices for techniques for data path address protection are described. As part of a write operation, the memory system may receive data associated with the write operation and an address for the data from a host system. The memory system may generate a first codeword using the address and may store both the first codeword and the data at the address. In some examples, the memory system may generate a second codeword using the data and the first codeword and store the second codeword along with the data and the first codeword. As part of a subsequent read operation for the data, the memory system may receive the address from the host system and retrieve the stored data and first codeword. The memory system may generate a third codeword using the address associated with the read operation and may compare the third codeword with the first codeword.

### CROSS REFERENCE

The present Application for Patent claims priority to U.S. Patent Application No. 63/512,480 by Richter et al., entitled “TECHNIQUES FOR DATA PATH ADDRESS PROTECTION,” filed Jul. 7, 2023, which is assigned to the assignee hereof, and which is expressly incorporated by reference in its entirety herein.

### TECHNICAL FIELD

The following relates to one or more systems for memory, including techniques for data path address protection.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports techniques for data path address protection in accordance with examples as disclosed herein.

FIGS. 2A and 2B show examples of systems that support techniques for data path address protection in accordance with examples as disclosed herein.

FIGS. 3A and 3B show examples of systems that support techniques for data path address protection in accordance with examples as disclosed herein.

FIG. 4 shows an example of a process flow that supports techniques for data path address protection in accordance with examples as disclosed herein.

FIG. 5 shows an example of a process flow that supports techniques for data path address protection in accordance with examples as disclosed herein.

FIG. 6 shows a block diagram of a memory device that supports techniques for data path address protection in accordance with examples as disclosed herein.

FIGS. 7 through 10 show flowcharts illustrating a method or methods that support techniques for data path address protection in accordance with examples as disclosed herein.

### DETAILED DESCRIPTION

Data within a memory system may move along a data path, for example as part of an access command from host system to store data to or retrieve data from an address within the memory system. In some cases, data moving along the data path may become corrupted (e.g., due to data path failures). Accordingly, some memory systems may implement error protection for various portions of the data along the data path of the memory system. For example, as part of a write operation the memory system may protect array data (e.g., user data, data stored to an array of the memory system) using an error correction code (ECC) scheme. The ECC scheme may generate a codeword, such as one or more check bits, using the array data, and the memory system may store the codeword and the array data to a memory array. Additionally, or alternatively, the codeword may be an example of a non-systemic codeword, in which the array data may be encoded (e.g., mixed) with one or more check bits. In such cases, the memory system may store the encoded codeword without storing the unencoded array data, such as if the ECC scheme includes a non-systematic code. However, some memory systems may not include error protection for other information associated with the access command, such as the address associated with the data. Because the address moving along an address path may also become corrupted, such memory systems may use a corrupted address as part of an access operation, which may result in the memory system accessing an incorrect address, thus reducing system reliability.

As described herein, a memory system may include error protection for an address. For example, as part of a write operation, the memory system may receive data associated with the write operation and an address for the data from a host system. The memory system may generate a first codeword using the address and may store both the first codeword and the data at the address. In some examples, the memory system may generate a second codeword using the data and the first codeword and store the second codeword and, in some cases, the data and the first codeword (e.g., as check bits). As part of a subsequent read operation for the data, the memory system may receive the address from the host system and retrieve the stored data and first codeword. The memory system may generate a third codeword using the address associated with the read operation and may compare the third codeword with the first codeword. If the first codeword and the third codeword do not match, the memory system may determine that an error occurred within the address received as part of the read operation, an error occurred within the address received as part of the write operation, or both. Implementing such techniques may allow the memory system to better manage the integrity of stored data, and thus improve system reliability.

Features of the disclosure are illustrated and described in the context of systems and architectures. Features of the disclosure are further illustrated and described in the context of system, process flows, and flowcharts.

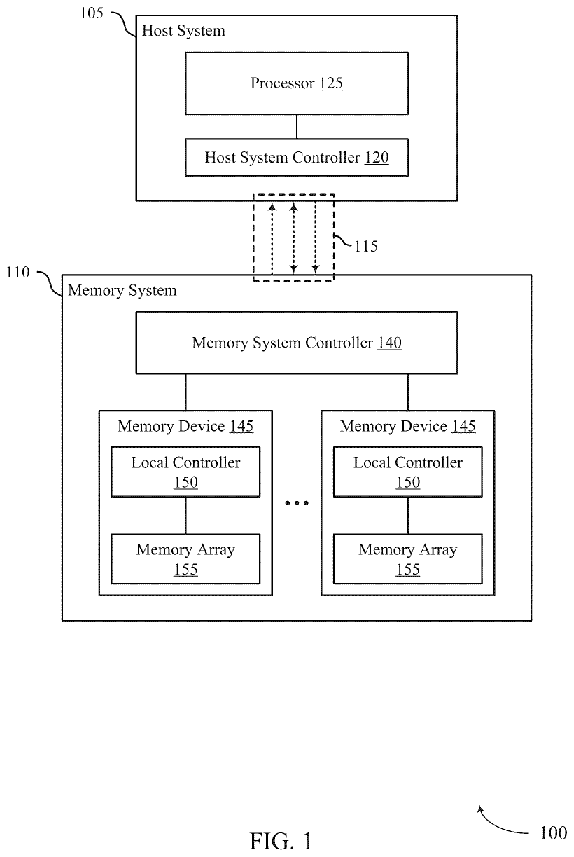

FIG. 1 illustrates an example of a system 100 that supports techniques for data path address protection in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some example, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some cases, a memory system 110 may include error protection for an address. For example, as part of a write operation, the memory system 110 may receive data associated with the write operation and an address for the data from a host system 105. The memory system 110 may generate a first codeword using the address and may store both the first codeword and the data at the address. In some examples, the memory system 110 may generate a second codeword using the data and the first codeword and store the second codeword along with the data and the first codeword (e.g., as check bits). As part of a subsequent read operation for the data, the memory system 110 may receive the address from the host system 105 and retrieve the stored data and first codeword. The memory system 110 may generate a third codeword using the address associated with the read operation and may compare the third codeword with the first codeword. If the first codeword and the third codeword do not match, the memory system 110 may determine that an error occurred within the address received as part of the read operation, an error occurred within the address received as part of the write operation, or both. Implementing such techniques may allow the memory system 110 to better manage the integrity of stored data, and thus improve system reliability.

In addition to applicability in systems as described herein, techniques for data path address protection may be generally implemented to improve the system reliability of various electronic devices and systems. Some electronic device applications, such as high-performance applications, may be associated with relatively high processing requirements or high data accuracy requirements (or both), while also benefitting from relatively quick response times to improve user experience. As such, increasing processing speed, decreasing response times, improving data integrity, or otherwise improving the performance electronic devices may be desirable. Implementing the techniques described herein may improve the performance of electronic devices by increasing the integrity of address information for stored data, which may decrease overhead associated with error processing and improve system reliability, among other benefits.

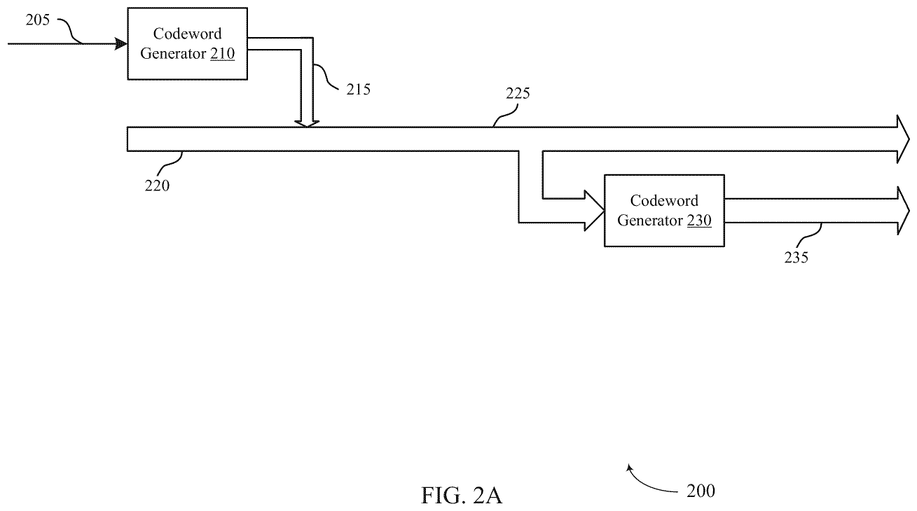

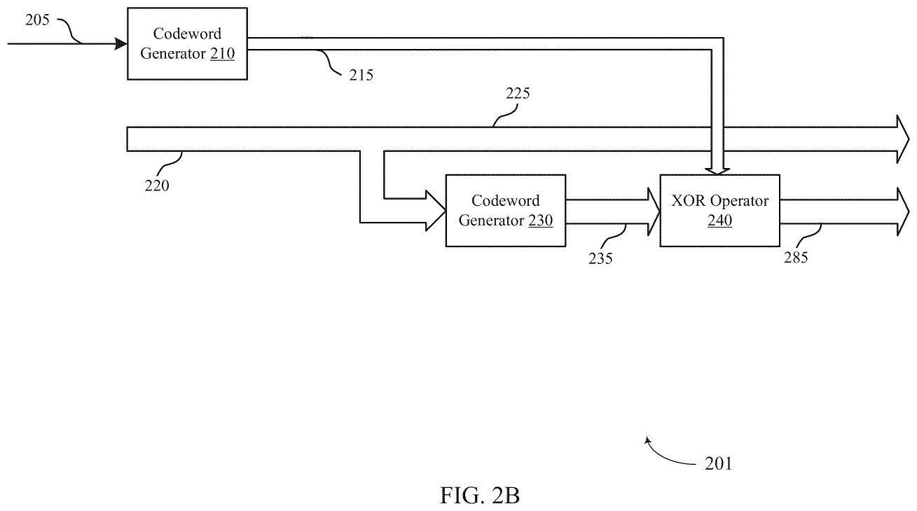

FIGS. 2A and 2B show examples of a system 200 and a system 201 that support techniques for data path address protection in accordance with examples as disclosed herein. The systems 200 and 201 may be examples of or may include aspects of a memory system 110. For example, the systems 200 and 201 may be implemented within a memory system controller 140 of a memory system 110, a local controller 150 of a memory device 145, or both, and may support the memory system 110 in executing access commands (e.g., read commands, write commands), including communicating information between a host system (e.g., a host system 105) and one or more memory arrays (e.g., one or more memory arrays 155).

In some cases, as part of executing an access operation, the memory system 110 may receive one or more commands and information associated with the one or more commands from the host system 105. For example, as part of a write operation, the memory system 110 may receive (e.g., from the host system 105) an activate command to activate (e.g., open) a row of memory cells within a bank of a memory array 155. Additionally, the memory system 110 may receive a row address, which may specify the location (e.g., logical location) of the row within the bank of the memory array 155. In some cases, the memory system 110 may temporarily store the row address, such as within an input latch, for use in subsequent commands. After activating the row specified by the row address, the memory system 110 may receive a write command, along with data 220, a bank address, and a column address, which may specify the location of the bank and the location of a column of memory cells within the bank. The memory system 110 may store the data 220 at the bank, row, and column specified by the bank address, the row address, and the column address, which may be collectively referred to as the address 205.

The systems 200 and 201 may support protection for the data 220 and the address 205 between storing the data 220 at the address 205 and subsequently reading the data 220 from the address 205. For example, the systems 200 and 201 may implement one or more error correction code (ECC) schemes, such as by generating one or more codewords which may be used to detect or correct (or both) errors within the data 220 and the address 205. In some cases, the one or more ECC schemes of the systems 200 and 201 may be implemented for a data path or a portion of the data path of the memory system 110. For example, the systems 200 and 201 may illustrate examples of an on-die ECC scheme, which may provide protection for a data path within a memory device 145. However, aspects of the systems 200 and 201 may be implemented within other portions of the data path of the memory system 110.

The systems 200 and 201 may illustrate one or more operations performed on the data 220 and the address 205 as part of a write operation to store the data 220 at the address 205 of a memory array. For example, the systems 200 and 201 may each include a codeword generator 210, which may generate a codeword 215 using the address 205. In some cases, the size of (e.g., the quantity of bits which comprise) the codeword 215 may be commensurate with the size of the address 205 and may be sufficient to allow the codeword 215 to detect or correct (or both) one or more errors within the address 205. In some examples, the codeword generator 210 may implement a first ECC scheme, and the codeword 215 may be an example of a checksum for the address 205.

By way of example, if the address 205 includes a bank address of a first size (e.g., four bits), a row address of a second size (e.g., 16 bits), and a column address of a third size (e.g., six bits), the codeword 215 may include a sufficient quantity of bits to detect or correct (or both) one or more errors within the combined bank address, row address, and column address. In some examples, the size of the codeword may be between eight and 16 bits, although one skilled in the art may appreciate that such a quantity is merely illustrative, and that other quantities are possible.

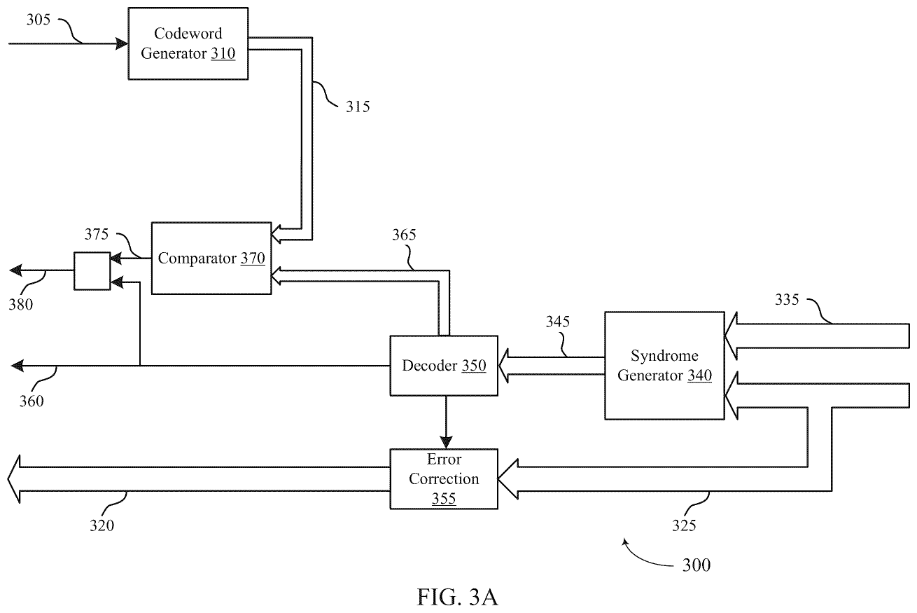

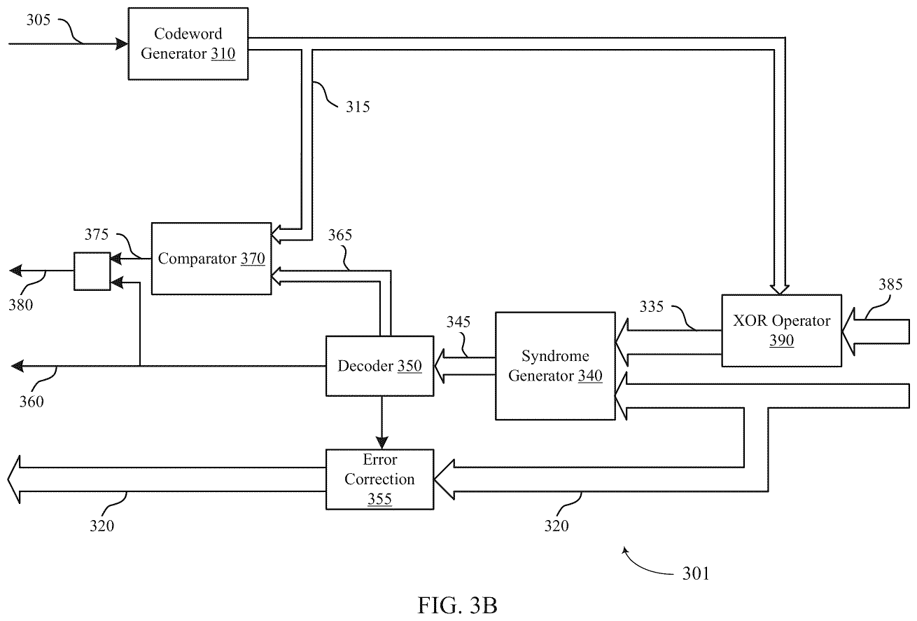

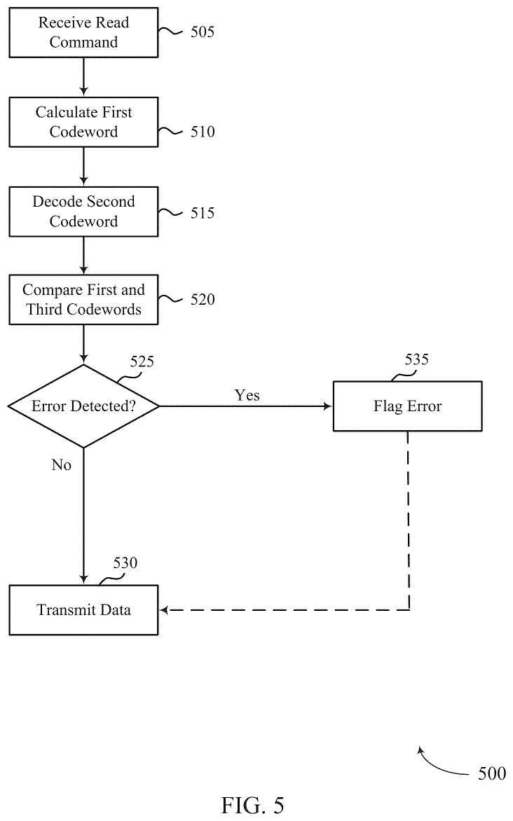

In some cases, the system 200 may combine the codeword 215 with the data 220 along the data path to generate combined data 225. For example, the system 200 may append the codeword 215 to the data 220, and thus increase the quantity of bits communicated along the data path. The system 200 may include a codeword generator 230, which may generate a codeword 235 using the combined data 225. Accordingly, the codeword 235 may support detecting or correcting (or both) one or more errors within both the data 220 and the codeword 215. In some examples, the codeword generator 230 may implement a second ECC scheme different than the first ECC scheme. The second ECC scheme may be, for example, a single error correction (SEC) scheme, a single error correction double error detection (SECDED) scheme, a double error correction (DEC) scheme, or a double error correction triple error detection (DECTED) scheme, and the codeword 235 may be an example of one or more check bits for the combined data 225. Additionally, or alternatively, the codeword 235 may be an example of non-systemic code, in which check bits are encoded with the combined data 225. The system 200 may store the combined data 225 and the codeword 235 to the address 205, which may be used in subsequent error correction operations for the data 220 (e.g., as part of a read operation for the data 220, as described in greater detail with reference to FIGS. 3A, 3B, and 5).

Alternatively, the system 201 may not append the codeword 215 with the data 220. Instead, the codeword generator 230 may generate a first codeword using the data 220 (e.g., without the codeword 215) and the system 200 may combine the first codeword with the codeword 215. For example, the system 200 may apply a function, such as an Exclusive-OR (XOR) operation using a XOR operator 240 to the first codeword and the codeword 215 to generate a third codeword. The system 200 may store the third codeword, along with the data 220, to the address 205 of the memory device.

In some cases, combining the codeword 215 with the first codeword to generate the third codeword may result in a relatively smaller size of information stored at the address 205, compared with appending the codeword 215 to the data 220 and storing the combined data 225 at the address 205, which may more efficiently utilize storage space within the memory device. However, combining the codeword 215 with the first codeword may also reduce the error correction capabilities of the system 200. For example, because the codeword 215 may be combined with the third codeword, the system 200 may be unable to distinguish between an error in the data 220 and an error in the address 205.

FIGS. 3A and 3B show examples of a system 300 and a system 301 that support techniques for data path address protection in accordance with examples as disclosed herein. The systems 300 and 301 may be examples of or may include aspects of a memory system 110, the system 200, or both. For example, the systems 300 and 301 may be implemented within a memory system controller 140 of a memory system 110, a local controller 150 of a memory device 145, or both, and may support the memory system 110 in executing access commands (e.g., read commands, write commands), including communicating information between a host system (e.g., a host system 105) and one or more memory arrays (e.g., one or more memory arrays 155). Additionally, the systems 300 and 301 may include a codeword generator 310, which may be an example of the codeword generator 210 as described with reference to FIGS. 2A and 2B, and may generate a codeword 315 (e.g., a checksum) using an address 305 received from a host system as part of an access operation, such as a read operation.

In some cases, as part of executing an access operation, the memory system 110 may receive one or more commands and information associated with the one or more commands from the host system 105. For example, as part of a read operation, the memory system 110 may receive (e.g., from the host system 105) an activate command to activate a row of memory cells within a bank of a memory array 155. Additionally, the memory system 110 may receive a row address, which may specify the location of the row within the bank of the memory array 155. In some cases, the memory system 110 may temporarily store the row address, such as within an input latch, for use in subsequent commands. After activating the row specified by the row address, the memory system 110 may receive a read command, a bank address, and a column address, which may specify the location of data 320 associated with the read command (e.g., the location of the bank and the location of a column of memory cells within the bank which store the data 320). In response to the read command, the memory system 110 may retrieve the data 320 from the bank, row, and column specified by the bank address, the row address, and the column address and transmit the data 320 to the host system.

The systems 300 and 301 may support protection for the data 320 and the address 305 between initially storing the data 320 at the address 305 and reading the data 320 from the address 305. For example, as part of the read operation, the system 300 may retrieve combined data 325, which may include the data 320 and a codeword 365, and a codeword 335. The codeword 365 may be an example of the codeword 215 as described with reference to FIG. 2A and may thus correspond to the address associated with a previous write operation to store the data 320. Further, the codeword 335 may correspond to a codeword generated using the data 320 and an address received from the host system as part of previously storing the data 320 (e.g., as part of the write operation to store the data 320). Additionally, the systems 300 and 301 may include a codeword generator 310, which may generate a codeword 315 using the address 305. In some examples, the codeword generator 310 may implement an ECC scheme, and the codeword 315 may be an example of a checksum for the address 305.

In some cases, (e.g., if the memory system implements the system 201 to combine the codeword 215 with the codeword 235 to generate the codeword 285), the system 301 may retrieve data 320 and a codeword 385. The system 301 may obtain the codeword 335 by applying a function (e.g., using the XOR operator 390) to the codeword 385 and the codeword 315.

The systems 300 and 301 may include a syndrome generator 340, which may generate a syndrome 345. In some cases, the system 300 may use the combined data 325 and the codeword 335 to generate the syndrome 345. Alternatively, the system 301 may use the data 320 and the codeword 335 to generate the syndrome 345. The syndrome 345 may include an indication of one or more errors (e.g., an error vector) within the combined data 325. Additionally, the systems 300 and 301 may include decoder 350 and an error correction component 355, which may use the syndrome 345 to decode the combined data 325 or the data 320 and, in some cases, correct one or more errors within the combined data 325 or data 320. In some cases, such as if the decoder 350 detects an error (e.g., an uncorrectable error) within the combined data 325 or data 320, the decoder 350 may generate a flag 360 indicating the error and may transmit the flag 360 to the host device.

In some cases, the system 300 may use the decoder 350 to separate the combined data 325 (e.g., after decoding the combined data 325) to obtain the data 320 and the codeword 365. The systems 300 and 301 may include a comparator 370, which may compare the codeword 365 with the codeword 315. For example, the comparator 370 may determine whether the codeword 315 and the codeword 365 match, such as by applying a XOR function to the codeword 315 and the codeword 365. If the comparator determines that the codeword 315 and the codeword 365 do not match, the comparator 370 may generate a flag 375, which may indicate that an error exists within the address 305 associated with the read operation or within the codeword 365 stored within the combined data 325. Such an error may indicate a fault associated with the received address 305, a fault associated with the address received as part of the previous write operation, a fault associated with storing the combined data 325, or a combination thereof.

In some cases, the systems 300 and 301 may store the flag 375, and the host system may subsequently retrieve an indication of the flag 375, for example as part of the read operation. Additionally, or alternatively, the system 300 may transmit an indication of the flag 375 to the host system. In some cases, the system 300 may combine the flag 360 with the flag 375 to generate a combined flag 380. For example, if the flag 360 and the flag 375 each include a respective bit value, the systems 300 and 301 may apply an AND-function to the flag 360 and the flag 375 to generate the combined flag 380. In such cases, the systems 300 and 301 may store the combined flag 380, and the host system may subsequently retrieve an indication of the combined flag 380. Additionally, or alternatively, the systems 300 and 301 may transmit an indication of the combined flag 380 to the host system.

In some examples, the system 200, the system 300, or both may support aspects of background operations for data stored to the memory array of the memory system. For example, the memory system may execute an error check and scrub (ECS) operation using the system 200 and the system 300. As part of the ECS operation, the memory system may maintain a counter to track an internal address. The memory system may read data from the address, such as the combined data 325 and the codeword 335, and use the codeword 335 to perform an error control operation on the data 320 and the codeword 365. Additionally, the memory system may use the internal address to generate a codeword 315 to compare with the codeword 365 using the comparator 370. If the comparator 370 detects an error, the memory system may flag the error and, in some cases, transmit an indication of the error to the host system.

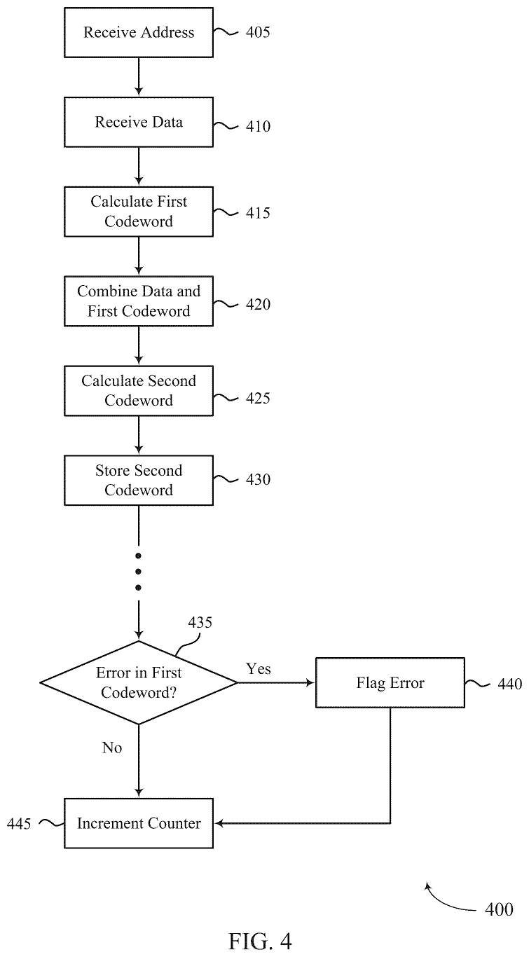

FIG. 4 shows an example of a process flow 400 that supports techniques for data path address protection in accordance with examples as disclosed herein. In some examples, a memory system, such as the memory system 110 as described with reference to FIG. 1, may implement the process flow 400 using a memory system controller (e.g., a memory system controller 140), a system 200 and a system 201 as described with reference to FIGS. 2A and 2B, or a combination thereof. In the following description of process flow 400, the operations may be performed in a different order than the order shown. For example, specific operations may also be left out of process flow 400, or other operations may be added to process flow 400.

The process flow 400 may illustrate a method to calculate a codeword (e.g., a checksum) for an address associated with a write operation and store the codeword along with data associated with the write operation in a memory device of the memory system. The memory system may use the codeword as part of a subsequent read operation to determine whether an error occurred along a data path for the address as part of the write operation, as part of the read operation, or both. Accordingly, by implementing the process flow 400, the memory system may improve the integrity of data and thus improve system reliability.

For example, at 405, the memory system may receive an address (e.g., a row address, a bank address, and a column address) associated with a write operation. In some cases, as part of the write operation, the memory system may receive an activate command from a host system (e.g., a host system 105) which includes a row address corresponding to a row within an array of the memory device of the memory system for the data. The memory system may temporarily store the row address, for example in an input latch of the memory device. Subsequently, the memory system may receive a write command, which may include a bank address and a column address corresponding to a bank associated with the array and a column of the array of the memory device. Additionally, as part of receiving the write command, the memory system may, at 410, receive the data from the host system.

At 415, the memory system may generate a first codeword for the address. For example, the memory system may apply a function to the address to generate the first codeword, such as an ECC scheme to generate a checksum. In some cases, the memory system may apply the function to the combination of the bank address, the row address, and the column address (e.g., the memory system may concatenate the bank address, the row address, and the column address, and may apply the function to the result of the concatenation).

At 420, the memory system may combine the first codeword with the data. For example, the memory system may append the first codeword to the data (e.g., may concatenate the data with the first codeword). The memory system may, at 425, generate a second codeword using the combined data and first codeword. In some cases, to generate the second codeword, the memory system may apply an error control code to the combined data and first codeword. (e.g., as part of an ECC scheme different than the ECC scheme used for the first codeword). Subsequently, the memory system may, at 430, store the combined data and first codeword, along with the second codeword, to the memory device at the address.

In some examples, the memory system may not combine the data with the first codeword (e.g., the process flow 400 may omit step 420). For example, the memory system may generate a third codeword using the data (e.g., without the first codeword) and may apply a second function to the first codeword and the third codeword to generate a fourth codeword. Subsequently, the memory system may store the data and fourth codeword to the memory device at the address.

In some cases, the second function may be an example of a XOR operation. Accordingly, the memory system may use the fourth codeword as part of a subsequent read operation, for example to obtain the third codeword. For example, as part of the read operation, the memory system may recalculate the first codeword (e.g., using an address associated with the read command) and apply a XOR operation to the first codeword and the fourth codeword to obtain the third codeword.

In some examples, the memory system may perform a background operation, such as an ECS operation. For example, the memory system may maintain a counter to track an internal address. The memory system may read from the address to obtain data stored at the address and a codeword generated as part previously storing the data at the address (e.g., the first codeword). Additionally, the memory system may generate a codeword using the internal address. At 435, the memory system may compare the retrieved codeword and the generated codeword to determine whether an error occurred in the retrieved codeword, the stored codeword, or both.

If the memory system detects an error, the memory system may, at 440, flag the error, such as by storing an indication of the error, transmitting an indication of the error to the host system, or both. Subsequently, the memory system may increment the counter (e.g., to a next address) and repeat steps 435 through 445 for the updated counter (e.g., for the next address).

FIG. 5 shows an example of a process flow 500 that supports techniques for data path address protection in accordance with examples as disclosed herein. In some examples, a memory system, such as the memory system 110 as described with reference to FIG. 1, may implement the process flow 500 using a memory system controller (e.g., a memory system controller 140), a system 300 and a system 301 as described with reference to FIGS. 3A and 3B, or a combination thereof. In the following description of process flow 500, the operations may be performed in a different order than the order shown. For example, specific operations may also be left out of process flow 500, or other operations may be added to process flow 500.

The process flow 500 may illustrate a method to determine whether an error occurred along a data path for an address for data stored in an array of a memory device of the memory system as part of the write operation, as part of the read operation, or both. The memory system may generate a first codeword using a first address associated with the read operation and may compare the first codeword to a second codeword previously generated using a second address associated with the write command and stored along with the data associated with the write command. Accordingly, by implementing the process flow 500, the memory system may improve the integrity of data and thus improve system reliability.

For example, at 505, the memory system may receive an address (e.g., a row address, a bank address, and a column address) associated with a read operation. In some cases, as part of the read operation, the memory system may receive an activate command from a host system (e.g., a host system 105) which includes a row address corresponding to a row within an array of the memory device of the memory system for the data. The memory system may temporarily store the row address, for example in an input latch of the memory device. Subsequently, the memory system may receive a read command, which may include a bank address and a column address corresponding to a bank associated with the array and a column of the array of the memory device at which the data is stored.

At 510, the memory system may generate a first codeword for the address. For example, the memory system may apply a function to the address to generate the first codeword, such as an ECC scheme to generate a checksum. In some cases, the memory system may apply the function to the combination of the bank address, the row address, and the column address (e.g., the memory system may concatenate the bank address, the row address, and the column address, and may apply the function to the result of the concatenation).

At 515, the memory system may identify a second codeword stored in a memory array at the address. For example, the memory system may retrieve data stored at the address, along with the second codeword. The second codeword may correspond to a codeword calculated using the data (e.g., as part of step 425 as described with reference to FIG. 4). In some examples, the data may include user data, as well as a third codeword corresponding to a codeword generated as part of previously storing the data (e.g., a codeword calculated using an address as part of step 415 as described with reference to FIG. 4). The memory system may use the second codeword to decode the data, for example by generating a syndrome (e.g., using the decoder 350 as described with reference to FIGS. 3A and 3B). As part of the decoding, the memory system may apply an error control code to correct an error in the data, in the third codeword, or both.

At 520, the memory system may perform an error control operation using the first codeword and the third codeword. For example, the memory system may compare the first codeword with the third codeword to determine whether they first codeword and the third codeword match. If the first codeword and the third codeword match, the memory system may, at 525, determine that there is no error within the address associated with the read command, the address associated with the write command, or both. Accordingly, the memory system may, at 530, transmit the data to the host system.

Alternatively, if the first codeword and the third codeword do not match, the memory system may, at 525, determine that an error occurred within the address associated with the read command, the address associated with the write command, or both. Accordingly, at 535, the memory system may flag the address error. In some cases, after storing the indication of the address error, the memory system may, at 530, transmit the data to the host system. Alternatively, the memory system may refrain from transmitting the data, and instead transmit the indication of the address error to the host system.

In some cases, the memory system may store an indication of the address error and may transmit the indication of the address error to the host system, for example in response to receiving a command to retrieve the indication of the address error. In some cases, the host system may determine to refrain from using memory cells associate with the address. In such cases, the host system may transmit a command to disable the one or more memory cells to the memory system, and the memory system may disable the one or more memory cells.

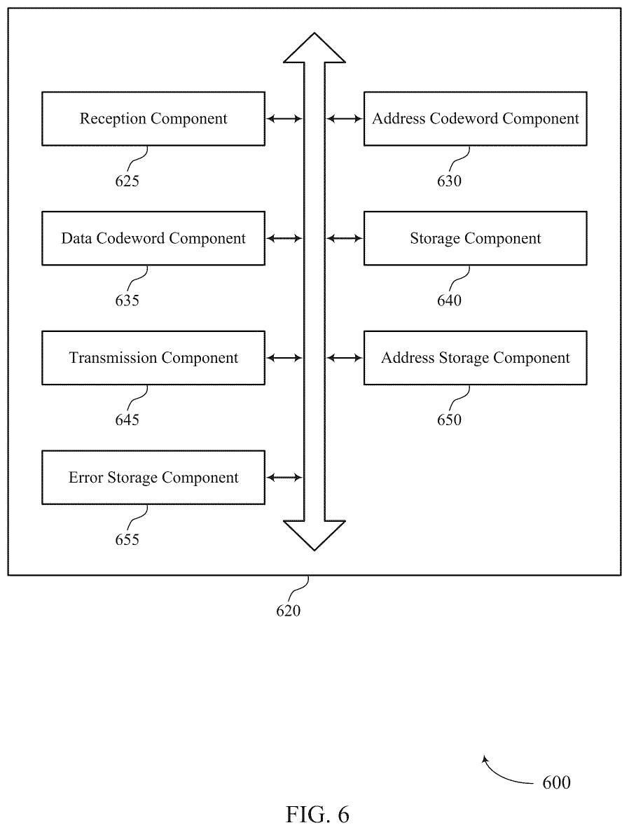

FIG. 6 shows a block diagram 600 of a memory device 620 that supports techniques for data path address protection in accordance with examples as disclosed herein. The memory device 620 may be an example of aspects of a memory device as described with reference to FIGS. 1 through 5. The memory device 620, or various components thereof, may be an example of means for performing various aspects of techniques for data path address protection as described herein. For example, the memory device 620 may include a reception component 625, an address codeword component 630, a data codeword component 635, a storage component 640, a transmission component 645, an address storage component 650, an error storage component 655, or any combination thereof. Each of these components, or components of subcomponents thereof (e.g., one or more processors, one or more memories), may communicate, directly or indirectly, with one another (e.g., via one or more buses).

The reception component 625 may be configured as or otherwise support a means for receiving data associated with a write command and an address associated with the write command. The address codeword component 630 may be configured as or otherwise support a means for generating a first codeword based at least in part on applying a function to the address. The data codeword component 635 may be configured as or otherwise support a means for generating a second codeword based at least in part on applying an error control code to the first codeword and the data. The storage component 640 may be configured as or otherwise support a means for storing the second codeword at the address.

In some examples, to support generating the second codeword, the data codeword component 635 may be configured as or otherwise support a means for appending the first codeword to the data to generate a combined codeword. In some examples, to support generating the second codeword, the data codeword component 635 may be configured as or otherwise support a means for applying the error control code to the combined codeword, where the second codeword is based at least in part on an output of the error control code.

In some examples, the reception component 625 may be configured as or otherwise support a means for receiving, as part of an activate command, a row address associated with the data and a bank address associated with the data, where receiving the write command is based at least in part on receiving the activate command.

In some examples, to support receiving the write command, the reception component 625 may be configured as or otherwise support a means for receiving a column address associated with the data, where generating the first codeword includes applying the function to the bank address, the row address, and the column address.

In some examples, the address storage component 650 may be configured as or otherwise support a means for storing, as part of executing the activate command, the row address at a bank associated with the bank address.

In some examples, the address includes a bank address associated with the data, a row address associated with the data, and a column address associated with the data.

In some examples, the address codeword component 630 may be configured as or otherwise support a means for identifying, as part of a background operation and based at least in part on an address counter corresponding to the address, the first codeword based at least in part on retrieving the second codeword from the address. In some examples, the address codeword component 630 may be configured as or otherwise support a means for generating a third codeword based at least in part on applying the function to the address. In some examples, the address codeword component 630 may be configured as or otherwise support a means for incrementing the address counter based at least in part on performing an error control procedure using the first codeword and the third codeword.

In some examples, to support performing the error control procedure, the address codeword component 630 may be configured as or otherwise support a means for identifying an error in the first codeword. In some examples, to support performing the error control procedure, the address codeword component 630 may be configured as or otherwise support a means for storing an indication of the error, where incrementing the address counter is based at least in part on storing the indication.

In some examples, to support performing the error control procedure, the address codeword component 630 may be configured as or otherwise support a means for determining that the first codeword and the third codeword match. In some examples, to support performing the error control procedure, the storage component 640 may be configured as or otherwise support a means for storing the first codeword at the address based at least in part on the determining.

In some examples, the function includes an error control operation different than the error control code.

In some examples, the reception component 625 may be configured as or otherwise support a means for receiving, from a host device, a read command for data and an address associated with the data. In some examples, the address codeword component 630 may be configured as or otherwise support a means for generating a first codeword based at least in part on applying a function to the address. In some examples, the data codeword component 635 may be configured as or otherwise support a means for identifying a second codeword stored in a memory array at the address. In some examples, the data codeword component 635 may be configured as or otherwise support a means for decoding the second codeword to obtain the data and a third codeword based at least in part on an error control code. In some examples, the address codeword component 630 may be configured as or otherwise support a means for performing an error control operation using the first codeword and the third codeword. The transmission component 645 may be configured as or otherwise support a means for transmitting the data to the host device based at least in part on performing the error control operation.

In some examples, the address codeword component 630 may be configured as or otherwise support a means for identifying an address error based at least in part on performing the error control operation. In some examples, the transmission component 645 may be configured as or otherwise support a means for transmitting an indication of the address error to the host device based at least in part on identifying address error.

In some examples, the error storage component 655 may be configured as or otherwise support a means for storing an indication of the address error.

In some examples, the reception component 625 may be configured as or otherwise support a means for receiving a command to retrieve the indication of the address error, where transmitting the indication of the address error to the host device is further based at least in part on receiving the command to retrieve the indication of the address error.

In some examples, the reception component 625 may be configured as or otherwise support a means for receiving, based at least in part on identifying the address error, a command to disable one or more memory cells associated with the address. In some examples, the storage component 640 may be configured as or otherwise support a means for disabling the one or more memory cells based at least in part on receiving the command to disable the one or more memory cells.

In some examples, to support identifying the second codeword, the reception component 625 may be configured as or otherwise support a means for retrieving the second codeword from the address. In some examples, to support identifying the second codeword, the data codeword component 635 may be configured as or otherwise support a means for applying an error control code to the second codeword based at least in part on retrieving the second codeword.

In some examples, to support applying the error control code, the address codeword component 630 may be configured as or otherwise support a means for identifying an error in the third codeword. In some examples, to support applying the error control code, the address codeword component 630 may be configured as or otherwise support a means for correcting the error, where performing the error control operation is based at least in part on correcting the error.

In some examples, the reception component 625 may be configured as or otherwise support a means for receiving, as part of an activate command, a row address associated with the data and a bank address associated with the data, where receiving the read command is based at least in part on receiving the activate command.

In some examples, to support performing the error control operation, the address codeword component 630 may be configured as or otherwise support a means for determining whether the first codeword matches the third codeword.

In some examples, the reception component 625 may be configured as or otherwise support a means for receiving data associated with a write command and an address associated with the write command. In some examples, the address codeword component 630 may be configured as or otherwise support a means for generating a first codeword based at least in part on applying a function to the address. In some examples, the data codeword component 635 may be configured as or otherwise support a means for generating a second codeword based at least in part on applying an error control code to the data. In some examples, the data codeword component 635 may be configured as or otherwise support a means for generating a third codeword based at least in part on applying a second function the first codeword and the second codeword. In some examples, the storage component 640 may be configured as or otherwise support a means for storing the data and the third codeword in a memory array at the address.

In some examples, the second function includes an Exclusive-OR operation.

In some examples, the first codeword and the second codeword each include a same quantity of bits.

In some examples, the reception component 625 may be configured as or otherwise support a means for receiving, from a host device, a read command for data and an address associated with the data. In some examples, the address codeword component 630 may be configured as or otherwise support a means for generating a first codeword based at least in part on applying a function to the address. In some examples, the data codeword component 635 may be configured as or otherwise support a means for identifying a second codeword and a third codeword stored in a memory array at the address. In some examples, the data codeword component 635 may be configured as or otherwise support a means for generating an error control code based at least in part on applying a second function to the first codeword and the third codeword. In some examples, the data codeword component 635 may be configured as or otherwise support a means for decoding the second codeword to obtain the data based at least in part on the error control code. In some examples, the transmission component 645 may be configured as or otherwise support a means for transmitting the data to a host device based at least in part on decoding the second codeword.

In some examples, the address codeword component 630 may be configured as or otherwise support a means for identifying an address error based at least in part on applying the second function. In some examples, the transmission component 645 may be configured as or otherwise support a means for transmitting an indication of the address error to the host device based at least in part on identifying the address error.

In some examples, the second function includes an Exclusive-OR operation.

In some examples, the described functionality of the memory device 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory device 620, or various components thereof, may be implemented at least in part by instructions (e.g., stored in memory, non-transitory computer-readable medium) executable by such at least one processor.

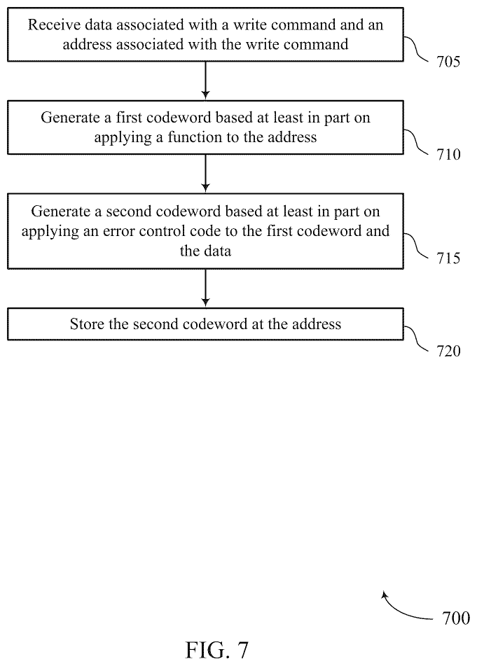

FIG. 7 shows a flowchart illustrating a method 700 that supports techniques for data path address protection in accordance with examples as disclosed herein. The operations of method 700 may be implemented by a memory device or its components as described herein. For example, the operations of method 700 may be performed by a memory device as described with reference to FIGS. 1 through 6. In some examples, a memory device may execute a set of instructions to control the functional elements of the device to perform the described functions. Additionally, or alternatively, the memory device may perform aspects of the described functions using special-purpose hardware.

At 705, the method may include receiving data associated with a write command and an address associated with the write command. In some examples, aspects of the operations of 705 may be performed by a reception component 625 as described with reference to FIG. 6.

At 710, the method may include generating a first codeword based at least in part on applying a function to the address. In some examples, aspects of the operations of 710 may be performed by an address codeword component 630 as described with reference to FIG. 6.

At 715, the method may include generating a second codeword based at least in part on applying an error control code to the first codeword and the data. In some examples, aspects of the operations of 715 may be performed by a data codeword component 635 as described with reference to FIG. 6.

At 720, the method may include storing the second codeword at the address. In some examples, aspects of the operations of 720 may be performed by a storage component 640 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving data associated with a write command and an address associated with the write command; generating a first codeword based at least in part on applying a function to the address; generating a second codeword based at least in part on applying an error control code to the first codeword and the data; and storing the second codeword at the address.

Aspect 2: The method, apparatus, or non-transitory computer-readable medium of aspect 1, where generating the second codeword includes operations, features, circuitry, logic, means, or instructions, or any combination thereof for appending the first codeword to the data to generate a combined codeword and applying the error control code to the combined codeword, where the second codeword is based at least in part on an output of the error control code.

Aspect 3: The method, apparatus, or non-transitory computer-readable medium of any of aspects 1 through 2, further including operations, features, circuitry, logic, means, or instructions, or any combination thereof for receiving, as part of an activate command, a row address associated with the data and a bank address associated with the data, where receiving the write command is based at least in part on receiving the activate command.

Aspect 4: The method, apparatus, or non-transitory computer-readable medium of aspect 3, where receiving the write command includes operations, features, circuitry, logic, means, or instructions, or any combination thereof for receiving a column address associated with the data, where generating the first codeword includes applying the function to the bank address, the row address, and the column address.

Aspect 5: The method, apparatus, or non-transitory computer-readable medium of any of aspects 3 through 4, further including operations, features, circuitry, logic, means, or instructions, or any combination thereof for storing, as part of executing the activate command, the row address at a bank associated with the bank address.

Aspect 6: The method, apparatus, or non-transitory computer-readable medium of any of aspects 1 through 5, where the address includes a bank address associated with the data, a row address associated with the data, and a column address associated with the data.

Aspect 7: The method, apparatus, or non-transitory computer-readable medium of any of aspects 1 through 6, further including operations, features, circuitry, logic, means, or instructions, or any combination thereof for identifying, as part of a background operation and based at least in part on an address counter corresponding to the address, the first codeword based at least in part on retrieving the second codeword from the address; generating a third codeword based at least in part on applying the function to the address; and incrementing the address counter based at least in part on performing an error control procedure using the first codeword and the third codeword.

Aspect 8: The method, apparatus, or non-transitory computer-readable medium of aspect 7, where performing the error control procedure includes operations, features, circuitry, logic, means, or instructions, or any combination thereof for identifying an error in the first codeword; and storing an indication of the error, where incrementing the address counter is based at least in part on storing the indication.

Aspect 9: The method, apparatus, or non-transitory computer-readable medium of any of aspects 7 through 8, where performing the error control procedure includes operations, features, circuitry, logic, means, or instructions, or any combination thereof for determining that the first codeword and the third codeword match and storing the first codeword at the address based at least in part on the determining.

Aspect 10: The method, apparatus, or non-transitory computer-readable medium of any of aspects 1 through 9, where the function includes an error control operation different than the error control code.

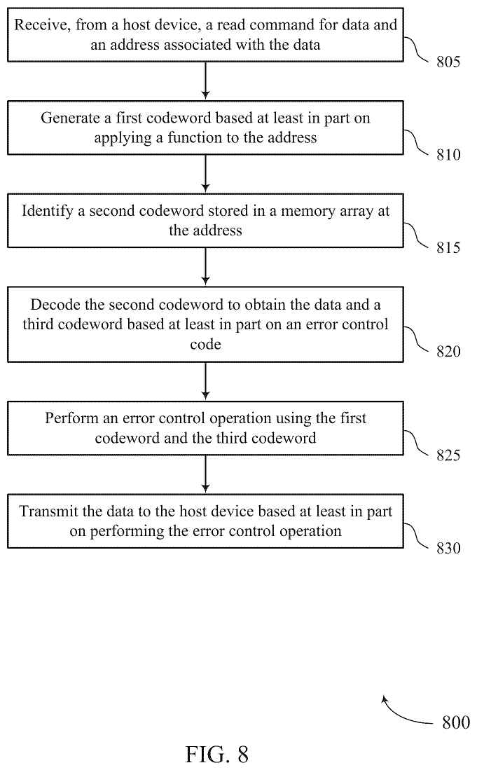

FIG. 8 shows a flowchart illustrating a method 800 that supports techniques for data path address protection in accordance with examples as disclosed herein. The operations of method 800 may be implemented by a memory device or its components as described herein. For example, the operations of method 800 may be performed by a memory device as described with reference to FIGS. 1 through 6. In some examples, a memory device may execute a set of instructions to control the functional elements of the device to perform the described functions. Additionally, or alternatively, the memory device may perform aspects of the described functions using special-purpose hardware.

At 805, the method may include receiving, from a host device, a read command for data and an address associated with the data. In some examples, aspects of the operations of 805 may be performed by a reception component 625 as described with reference to FIG. 6.

At 810, the method may include generating a first codeword based at least in part on applying a function to the address. In some examples, aspects of the operations of 810 may be performed by an address codeword component 630 as described with reference to FIG. 6.

At 815, the method may include identifying a second codeword stored in a memory array at the address. In some examples, aspects of the operations of 815 may be performed by a data codeword component 635 as described with reference to FIG. 6.

At 820, the method may include decoding the second codeword to obtain the data and a third codeword based at least in part on an error control code. In some examples, aspects of the operations of 820 may be performed by a data codeword component 635 as described with reference to FIG. 6.

At 825, the method may include performing an error control operation using the first codeword and the third codeword. In some examples, aspects of the operations of 825 may be performed by an address codeword component 630 as described with reference to FIG. 6.

At 830, the method may include transmitting the data to the host device based at least in part on performing the error control operation. In some examples, aspects of the operations of 830 may be performed by a transmission component 645 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving, from a host device, a read command for data and an address associated with the data; generating a first codeword based at least in part on applying a function to the address; identifying a second codeword stored in a memory array at the address; decoding the second codeword to obtain the data and a third codeword based at least in part on an error control code; performing an error control operation using the first codeword and the third codeword; and transmitting the data to the host device based at least in part on performing the error control operation.

Aspect 12: The method, apparatus, or non-transitory computer-readable medium of aspect 11, further including operations, features, circuitry, logic, means, or instructions, or any combination thereof for identifying an address error based at least in part on comparing the first codeword and the third codeword and transmitting an indication of the address error to the host device based at least in part on identifying address error.

Aspect 13: The method, apparatus, or non-transitory computer-readable medium of aspect 12, further including operations, features, circuitry, logic, means, or instructions, or any combination thereof for storing an indication of the address error.

Aspect 14: The method, apparatus, or non-transitory computer-readable medium of aspect 13, further including operations, features, circuitry, logic, means, or instructions, or any combination thereof for receiving a command to retrieve the indication of the address error, where transmitting the indication of the address error to the host device is further based at least in part on receiving the command to retrieve the indication of the address error.

Aspect 15: The method, apparatus, or non-transitory computer-readable medium of any of aspects 12 through 14, further including operations, features, circuitry, logic, means, or instructions, or any combination thereof for receiving, based at least in part on identifying the address error, a command to disable one or more memory cells associated with the address and disabling the one or more memory cells based at least in part on receiving the command to disable the one or more memory cells.

Aspect 16: The method, apparatus, or non-transitory computer-readable medium of any of aspects 11 through 15, where identifying the second codeword includes operations, features, circuitry, logic, means, or instructions, or any combination thereof for retrieving the second codeword from the address and applying an error control code to the second codeword based at least in part on retrieving the second codeword.

Aspect 17: The method, apparatus, or non-transitory computer-readable medium of aspect 16, where applying the error control code includes operations, features, circuitry, logic, means, or instructions, or any combination thereof for identifying an error in the third codeword and correcting the error, where performing the error control operation is based at least in part on correcting the error.

Aspect 18: The method, apparatus, or non-transitory computer-readable medium of any of aspects 11 through 17, further including operations, features, circuitry, logic, means, or instructions, or any combination thereof for receiving, as part of an activate command, a row address associated with the data and a bank address associated with the data, where receiving the read command is based at least in part on receiving the activate command.

Aspect 19: The method, apparatus, or non-transitory computer-readable medium of any of aspects 11 through 18, where performing the error control operation includes operations, features, circuitry, logic, means, or instructions, or any combination thereof for determining whether the first codeword matches the third codeword.

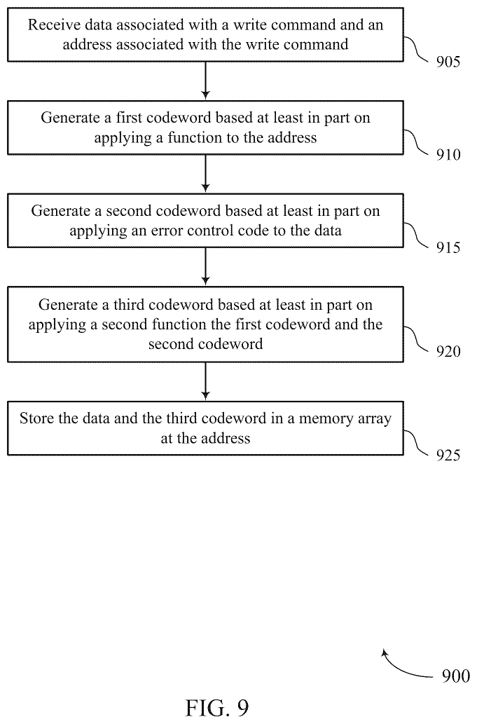

FIG. 9 shows a flowchart illustrating a method 900 that supports techniques for data path address protection in accordance with examples as disclosed herein. The operations of method 900 may be implemented by a memory device or its components as described herein. For example, the operations of method 900 may be performed by a memory device as described with reference to FIGS. 1 through 6. In some examples, a memory device may execute a set of instructions to control the functional elements of the device to perform the described functions. Additionally, or alternatively, the memory device may perform aspects of the described functions using special-purpose hardware.

At 905, the method may include receiving data associated with a write command and an address associated with the write command. In some examples, aspects of the operations of 905 may be performed by a reception component 625 as described with reference to FIG. 6.

At 910, the method may include generating a first codeword based at least in part on applying a function to the address. In some examples, aspects of the operations of 910 may be performed by an address codeword component 630 as described with reference to FIG. 6.

At 915, the method may include generating a second codeword based at least in part on applying an error control code to the data. In some examples, aspects of the operations of 915 may be performed by a data codeword component 635 as described with reference to FIG. 6.

At 920, the method may include generating a third codeword based at least in part on applying a second function the first codeword and the second codeword. In some examples, aspects of the operations of 920 may be performed by a data codeword component 635 as described with reference to FIG. 6.

At 925, the method may include storing the data and the third codeword in a memory array at the address. In some examples, aspects of the operations of 925 may be performed by a storage component 640 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 20: A method, apparatus, or non-transitory computer-readable medium including operations, features, circuitry, logic, means, or instructions, or any combination thereof for receiving data associated with a write command and an address associated with the write command; generating a first codeword based at least in part on applying a function to the address; generating a second codeword based at least in part on applying an error control code to the data; generating a third codeword based at least in part on applying a second function the first codeword and the second codeword; and storing the data and the third codeword in a memory array at the address.

Aspect 21: The method, apparatus, or non-transitory computer-readable medium of aspect 20, where the second function includes an Exclusive-OR operation.

Aspect 22: The method, apparatus, or non-transitory computer-readable medium of any of aspects 20 through 21, where the first codeword and the second codeword each include a same quantity of bits.

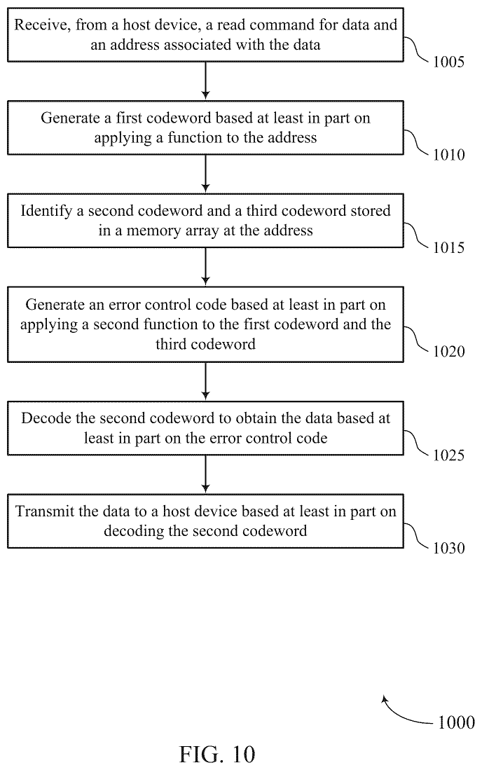

FIG. 10 shows a flowchart illustrating a method 1000 that supports techniques for data path address protection in accordance with examples as disclosed herein. The operations of method 1000 may be implemented by a memory device or its components as described herein. For example, the operations of method 1000 may be performed by a memory device as described with reference to FIGS. 1 through 6. In some examples, a memory device may execute a set of instructions to control the functional elements of the device to perform the described functions. Additionally, or alternatively, the memory device may perform aspects of the described functions using special-purpose hardware.

At 1005, the method may include receiving, from a host device, a read command for data and an address associated with the data. In some examples, aspects of the operations of 1005 may be performed by a reception component 625 as described with reference to FIG. 6.

At 1010, the method may include generating a first codeword based at least in part on applying a function to the address. In some examples, aspects of the operations of 1010 may be performed by an address codeword component 630 as described with reference to FIG. 6.

At 1015, the method may include identifying a second codeword and a third codeword stored in a memory array at the address. In some examples, aspects of the operations of 1015 may be performed by a data codeword component 635 as described with reference to FIG. 6.

At 1020, the method may include generating an error control code based at least in part on applying a second function to the first codeword and the third codeword. In some examples, aspects of the operations of 1020 may be performed by a data codeword component 635 as described with reference to FIG. 6.

At 1025, the method may include decoding the second codeword to obtain the data based at least in part on the error control code. In some examples, aspects of the operations of 1025 may be performed by a data codeword component 635 as described with reference to FIG. 6.

At 1030, the method may include transmitting the data to a host device based at least in part on decoding the second codeword. In some examples, aspects of the operations of 1030 may be performed by a transmission component 645 as described with reference to FIG. 6.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 23: A method, apparatus, or non-transitory computer-readable medium including operations, features, circuitry, logic, means, or instructions, or any combination thereof for receiving, from a host device, a read command for data and an address associated with the data; generating a first codeword based at least in part on applying a function to the address; identifying a second codeword and a third codeword stored in a memory array at the address; generating an error control code based at least in part on applying a second function to the first codeword and the third codeword; decoding the second codeword to obtain the data based at least in part on the error control code; and transmitting the data to a host device based at least in part on decoding the second codeword.

Aspect 24: The method, apparatus, or non-transitory computer-readable medium of aspect 23, further including operations, features, circuitry, logic, means, or instructions, or any combination thereof for identifying an address error based at least in part on applying the second function and transmitting an indication of the address error to the host device based at least in part on identifying the address error.

Aspect 25: The method, apparatus, or non-transitory computer-readable medium of any of aspects 23 through 24, where the second function includes an Exclusive-OR operation.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

Illustrative blocks and modules described herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, that can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or a processor.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving data associated with a write command and an address associated with the write command;
generating a first codeword based at least in part on applying a function to the address;
generating a second codeword based at least in part on applying an error control code to the first codeword and the data; and
storing the second codeword at the address.

2. The method of claim 1, wherein generating the second codeword comprises:
appending the first codeword to the data to generate a combined codeword; and
applying the error control code to the combined codeword, wherein the second codeword is based at least in part on an output of the error control code.

3. The method of claim 1, further comprising:
receiving, as part of an activate command, a row address associated with the data and a bank address associated with the data, wherein receiving the write command is based at least in part on receiving the activate command.

4. The method of claim 3, wherein receiving the write command comprises:
receiving a column address associated with the data, wherein generating the first codeword comprises applying the function to the bank address, the row address, and the column address.

5. The method of claim 3, further comprising:
storing, as part of executing the activate command, the row address at a bank associated with the bank address.

6. The method of claim 1, wherein the address comprises a bank address associated with the data, a row address associated with the data, and a column address associated with the data.

7. The method of claim 1, further comprising:
identifying, as part of a background operation and based at least in part on an address counter corresponding to the address, the first codeword based at least in part on retrieving the second codeword from the address;
generating a third codeword based at least in part on applying the function to the address; and
incrementing the address counter based at least in part on performing an error control procedure using the first codeword and the third codeword.

8. The method of claim 7, wherein performing the error control procedure comprises:
identifying an error in the first codeword; and
storing an indication of the error, wherein incrementing the address counter is based at least in part on storing the indication.

9. The method of claim 7, wherein performing the error control procedure comprises:
determining that the first codeword and the third codeword match; and
storing the first codeword at the address based at least in part on determining that the first codeword and the third codeword match.

10. The method of claim 1, wherein the function comprises an error control operation different than the error control code.

11. A method, comprising:
receiving, from a host device, a read command for data and an address associated with the data;
generating a first codeword based at least in part on applying a function to the address;
identifying a second codeword stored in a memory array at the address;
decoding the second codeword to obtain the data and a third codeword based at least in part on an error control code;
performing an error control operation using the first codeword and the third codeword; and
transmitting the data to the host device based at least in part on performing the error control operation.

12. The method of claim 11, further comprising:
identifying an address error based at least in part on comparing the first codeword and the third codeword; and
transmitting an indication of the address error to the host device based at least in part on identifying address error.

13. The method of claim 12, further comprising:
storing an indication of the address error.

14. The method of claim 13, further comprising:
receiving a command to retrieve the indication of the address error, wherein transmitting the indication of the address error to the host device is further based at least in part on receiving the command to retrieve the indication of the address error.

15. The method of claim 12, further comprising:
receiving, based at least in part on identifying the address error, a command to disable one or more memory cells associated with the address; and
disabling the one or more memory cells based at least in part on receiving the command to disable the one or more memory cells.

16. The method of claim 11, wherein identifying the second codeword comprises:
retrieving the second codeword from the address; and
applying an error control code to the second codeword based at least in part on retrieving the second codeword.

17. The method of claim 16, wherein applying the error control code comprises:
identifying an error in the third codeword; and
correcting the error, wherein performing the error control operation is based at least in part on correcting the error.

18. The method of claim 11, further comprising:
receiving, as part of an activate command, a row address associated with the data and a bank address associated with the data, wherein receiving the read command is based at least in part on receiving the activate command.

19. The method of claim 11, wherein performing the error control operation comprises:
determining whether the first codeword matches the third codeword.

20. A method, comprising:
receiving data associated with a write command and an address associated with the write command;
generating a first codeword based at least in part on applying a function to the address;
generating a second codeword based at least in part on applying an error control code to the data;
generating a third codeword based at least in part on applying a second function the first codeword and the second codeword; and
storing the data and the third codeword in a memory array at the address.

21. The method of claim 20, wherein the second function comprises an Exclusive-OR operation.

22. The method of claim 20, wherein the first codeword and the second codeword each comprise a same quantity of bits.

23. A method, comprising:
receiving, from a host device, a read command for data and an address associated with the data;
generating a first codeword based at least in part on applying a function to the address;
identifying a second codeword and a third codeword stored in a memory array at the address;
generating an error control code based at least in part on applying a second function to the first codeword and the third codeword;
decoding the second codeword to obtain the data based at least in part on the error control code; and
transmitting the data to a host device based at least in part on decoding the second codeword.

24. The method of claim 23, further comprising:
identifying an address error based at least in part on applying the second function; and
transmitting an indication of the address error to the host device based at least in part on identifying the address error.

25. The method of claim 23, wherein the second function comprises an Exclusive-OR operation.
